(19) United States
(12) Patent Application Publication
(10) Pub. No.: US 2021/0147261 A1
(43) Pub. Date: May 20, 2021

(54) FLUID TREATMENT DEVICE

(71) Applicant: Richard Marcelin Wambsgans, Gallatin Gateway, MT (US)

(72) Inventor: Richard Marcelin Wambsgans, Gallatin Gateway, MT (US)

(21) Appl. No.: 16/684,160

(22) Filed: Nov. 14, 2019

(51) Int. Cl. C02F 1/34; C02F 1/00; C02F 1/66; C02F 1/461; C02F 103/42; C02F 103/00

(52) U.S. Cl. CPC C02F 1/34; C02F 1/001; C02F 1/66; C02F 2103/007; C02F 2303/04; C02F 2103/42; C02F 2001/46133; C02F 1/46109

(57) ABSTRACT

A purification device and method for creating fluid nucleation in situ, is disclosed. the device is configured to operatively connect to an outline flow of a purifying system for ponds, swimming pools, spas, and fountains for cleaning and maintaining the pH level of the fluid/water. The device has a cylindrical housing with a hollow interior, an inlet, and an outlet, wherein the hollow interior of the cylindrical housing defines a fluid nucleation zone, a plurality of elongated tubes securely positioned within the housing, wherein the plurality of elongated tubes is configured to allow the fluid via the inlet, one or more diffusers securely disposed at one end of the plurality of elongated tubes within the cylindrical housing, wherein the one or more diffusers are configured to break bonds between adjoining fluid molecules, thereby creating to fluid nucleation process within the fluid nucleation zone in cylindrical housing to clean the fluid, a copper cathode disposed within the cylindrical housing, wherein the copper cathode is configured to balance the pH of the fluid, and a nozzle having a predetermined amount of perforations therein, wherein the nozzle is configured to securely affixed to the outlet of the cylindrical housing for controlling a flow of the fluid.

### FIELD OF THE INVENTION

The present invention relates to a device and method to treat, disinfect or clean a fluid by creating cavitation in the fluid such as water. More particularly, the invention relates to a water disinfecting and purification, and pH optimizing device that is operable with existing pumps to create nano-particle water nucleation sites in situ, thereby disinfecting and cleaning water by removing biologics, organisms, and debris whilst optimizing pH level depending upon the desired end-use.

### BACKGROUND OF THE INVENTION

Swimming pools, including indoor and outdoor aquatic facilities, natatoriums, spas, splash pads, lazy rivers, water slides, wave pools, and water parks, are subject to contamination from foreign matters introduced into the water by swimmers, wind, rain and articles used in and about the water. Such contamination may include particles of dirt, organic matter, bacteria, algae, hair, makeup, suntan and -body oils, leaves, mineral residue from chemicals and other debris.

Further, farm ponds, golf course ponds, and other bodies of water are similarly subject to contamination but because they are generally untreated, contain an even higher degree of debris and harmful biologics. Specifically, on livestock farms animal feces and contaminate ponds, whilst on olericulture farms (i.e., vegetables, hemp, cannabis), fertilizers and other chemical agents from non-point runoff lead to contamination and out of control algae growth.

Filtration is the mechanical process of removing these contaminants from the pool water. Most modern pools comprise pool filtration facilities as part of the pool water recirculation systems. Pool water carrying particulate matter, solids and debris is passed through filtering equipment as it is recirculated. The filtering equipment removes maximum amount of contamination from the water and returns the clean water to the pool. It is known that the clarity of the returned water is an indication of its cleanliness, and is important for appearance, hygiene, sanitation, and safety.

However, conventional water treatment plants and purifying systems may not successfully treat 100% of the water due to volume and distribution, and the use of chemicals is undesirable. For instance, it is not possible to maintain proper flow rates in all distribution lines. Further, the conventional water treatment plants and purifying systems using chemicals such as, but not limited to, ozone or chlorine as a treatment step and attempt to maintain the water clean. Unfortunately, chlorine reacts with other naturally-occurring elements in the water that may cause sickness/illness ranging from asthma and eczema to severe bladder cancer and heart diseases.

Many farm ponds are treated with chemicals, or need to be periodically serviced to make the water usable.

In addition, water molecules tend to attract towards each other and create a bond or surface tension that bridges between the molecules, thereby reducing the total exposed surface area of the water molecules when grouped together compared to being independent of each other.

One method of breaking these bonds is through cavitation. Cavitation is defined as the formation of vapor cavities in a liquid, small liquid-free zones, that are the consequence of forces acting upon the liquid. It usually occurs when a liquid is subjected to rapid changes of pressure that cause the formation of cavities in the liquid where the pressure is relatively low.

Classically, cavitation was a phenomenon to be prevented because of the significant deleterious effects on equipment and causes damages to the rotor blades and the like. Collapsing voids that implode near a metal surface cause cyclic stress through repeated implosion. This results in surface fatigue of the metal causing a type of wear called as “cavitation”. The most common examples of this kind of wear are to pump impellers and bends where a sudden change in the direction of liquid occurs.

However, if it is harnessed appropriately, cavitation can be used for cleaning of wastewater and can remove various particulates, metals, bacterium (e.g. cyanobacteria) green microalgae (e.g., Chlorella Vulgaris), and viruses (Rotavirus) from water, while balancing pH level. Swimming pool water, for example, may comprises bacteria, such as E. coli, shigella (which causes dysentery), campylobacter and salmonella. The addition of chlorine can kill a majority of the bacterium, harmful metals may build up in the water, two being iron and copper, each of which is undesirable.

What is needed is a water purification device that can be connected to existing pumps or outline flows for disinfecting water that obviates the issues with the conventional systems and methods.

### SUMMARY OF THE INVENTION

To achieve the foregoing and other aspects and in accordance with the purpose of the invention, the subject invention provides a purification device for creating fluid nucleation in situ. In one embodiment, the device is configured to securely and operatively connect to an outline flow or a back-flow pipe of a purifying system for at least any one of, but not limited to, swimming pools, farm ponds, spas, and fountains for disinfecting, cleaning and maintaining the pH level of fluid/water.

In one embodiment, the device is manufactured with varying sizes and dimensions, lengths, and diameters to accommodate various end uses. In one embodiment, the device comprises a cylindrical housing defining a housing with a hollow interior, an inlet, and an outlet. In one embodiment, the hollow interior of the cylindrical housing defines a fluid nucleation zone. In one embodiment, the cylindrical housing is made of a metals, plastic, metal alloys, or ceramics. In one embodiment, the device comprises a plurality of elongated tubes, and a copper cathode fitted between the tubes in a center gap or apertures. The plurality of elongated tubes are securely positioned within the housing and allow for fluid flow in a cavitation zone. The elongated tubes together with the diffuser, and nozzle create cavitation in the fluid form fluid nano-clusters and free radicals.

In an exemplary embodiments, the elongated tubes may be retained by a series of baffles disposed between the diffusers and the nozzle in the hollow interior of the housing. In operation, the copper cathode has a pH balancing effect to the fluid.

In exemplary embodiments, the device further comprises at least one nozzle and one or more diffusers. The diffusers are securely positioned at one end of the plurality of elongated tubes within the cylindrical housing of the device. The diffusers are configured to break bonds between adjoining fluid molecules, thereby creating the fluid nucleation process within the cylindrical housing and cleaning the fluid. The separated fluid molecules flow through the elongated tubes in a suspended state for balancing the pH level of the fluid. In one embodiment, the nozzle is securely affixed to the outlet of the cylindrical housing using, but not limited to, fasteners or an adhesives. The nozzle is configured to control the flow of the purified or disinfected fluid In one embodiment, the device includes at least one copper cathode, securely positioned between the elongated tubes within the cylindrical housing. The copper cathode within the cylindrical operates to balance the pH of the fluid. In one embodiment, the copper cathode has a diameter of about, but not limited to, 1.27 centimeters.

In an exemplary embodiment, the nozzle comprises a predetermined amount of perforations or holes. The nozzle is located at an outlet of the cylindrical housing for controlling the flow of the fluid. The diameter of the nozzle may be varied based on the fluid to be cleaned. In one embodiment, the nozzle is manufactured with a diameter of approximately 5 centimeters. In another embodiment, the nozzle could be manufactured with a diameter of about, but not limited to, 7 centimeters.

In an exemplary embodiment, a first diffuses are securely positioned at the inlet of the housing and is in fluid communication with the elongated tubes. The diffusers are configured to break bonds between adjoining fluid molecules under pressure, thereby creating the fluid nucleation process within the cylindrical housing, creating free radicals and cleaning the fluid. In one embodiment, the diffusers are, but not limited to, circular elements having orifices with beveled edges to create a venturi effect. The diffusers also act as a filter to prevent the influx of particles of a predetermined size. The plurality of orifices increase pressure on the fluid to create a heat signature for cleaning the fluid of foreign matter. In one embodiment, the diameter of the plurality of orifices of each diffuser are varied according to the fluid to be cleaned. In an exemplary embodiment, each orifice of the diffusers has a width of about, but not limited to, 0.0712 centimeters

In one embodiment, the device is securely and removably affixed to an outflow line or back-flow pipe of a purifying system for swimming pools, farm ponds, fountains or spas, using a first connection member and a second connection member. In one embodiment, the first connection member at the inlet of the device is securely and threadedly connected to one end of the outflow line or back-flow pipe and the second connection member at the outlet of the device is securely connected to a pipe, which is connected to an inlet of the at least any one of the swimming pool, farm pond, spa or fountain. In one embodiment, the first connection member comprises a threaded tubular, which is configured to connect to the one end of the outflow line or back-flow pipe. In one embodiment, the second connection member comprises a threaded tubular, which is configured to connect to a pipe that is connected to an inlet the swimming pool, the spa, the pond, or the fountain.

The device provides an intermediary device that is positioned within the water flow of a pool, spa, fountain or other bodies of water, and utilizes pressure created from a pump together with e elements positioned there to create cavitation and clean the fluid whilst balancing the pH of the fluid without using chemicals.

The device provides a fission process that breaks the bond between adjoining fluid molecules and creates a heat signature that forces the water molecules apart in a hydrophobic environment creating free radicals and burning off any foreign matter and particulates, thereby effectively cleaning the fluid molecule and balancing pH without using chemicals.

The device further provide water free of bacteria, algae, and other foreign matter and contaminants while maintaining a balanced pH level of water for at least any one of, but not limited to, a swimming pool, a spa, ad a fountain.

The device also prevents calcification around nozzle heads.

Other features, advantages, and aspects of the present invention will become more apparent and be more readily understood from the following detailed description, which should be read in conjunction with the accompanying drawings.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a side view of a purification device for creating fluid nucleation in situ according to an embodiment of the present invention;

FIG. 2 is a perspective view of the purification device for creating fluid nucleation in situ, according to one embodiment of the present invention;

FIG. 3a is a side view of an orifices of the diffuser according to one embodiment of the present invention;

FIG. 3b is front view of the diffuser;

FIG. 4a is a perspective view of the purification device showing a cylindrical housing with a plurality of elongated tubes in an embodiment of the present invention;

FIG. 4b is a perspective view of the purification device showing a cylindrical housing with a plurality of elongated tubes and end cap in an embodiment of the present invention;

FIG. 5 is a top perspective view of the nozzle of the purification device in an embodiment of the present invention;

FIG. 6 is a top perspective view of the cylindrical housing with a copper cathode and the plurality of elongated tubes in an embodiment of the present invention;

FIG. 7 is a top perspective view of the cylindrical housing of the purification device with one or more diffusers in an embodiment of the present invention;

FIG. 8 is a flow-chart showing a use-case of the device at an agricultural pond in an exemplary embodiment of the present invention;

FIG. 9 is schematic diagram of the purification device securely installed and fluidly connected to an outflow line or back-flow pipe of a purifying system for a swimming pool/spa/fountain in an embodiment of the present invention;

FIG. 10 exemplarily illustrates a flowchart of a method for creating fluid nucleation in situ in an embodiment of the present invention.

### DETAILED DESCRIPTION OF THE PREFERRED EMBODIMENTS

The present invention is best understood by reference to the detailed description and examples set forth herein.

Embodiments of the invention are discussed below with reference to the examples. However, those skilled in the art will readily appreciate that the detailed description given herein with respect to these examples is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention.

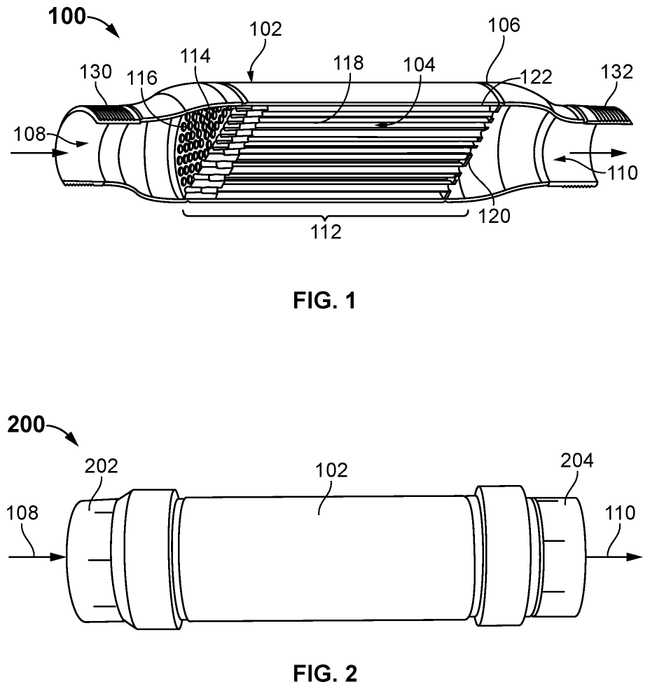

Referring now to FIG. 1, a fluid purification, disinfecting, treatment and/or pH balancing device is shown generally at 100. The device is and insertable into existing fluid treatment systems and in operation generates a hydrodynamic cavitation zone in situ. The device 100 comprises a housing 102, having a hollow interior 104, an outer cylindrical wall 106, an inlet 108 and an outlet 110, cavitation zone 112, at least one diffuser 114 and a nozzle (shown in relation to FIG.).

The housing 102 may be formed of metals, metal alloys, or ceramics. However, optional embodiments, any material with a hardness that will stand up to the effects of cavitation may be use.

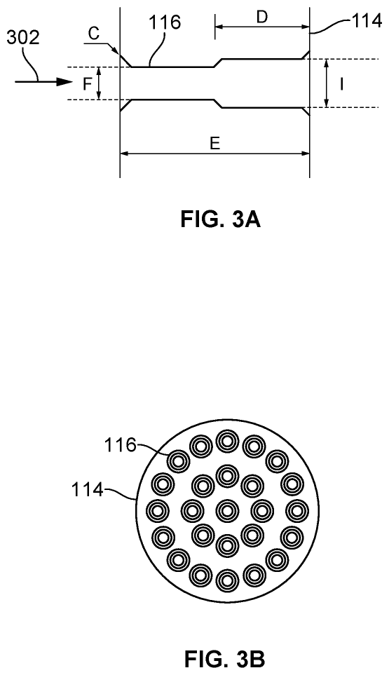

In one embodiment, the cavitation zone 112 comprises a plurality of elongated tubes 118 that are concentrically positioned inside the housing 102. The inner cylindrical housings are shown in FIG. 3. In one embodiment, a first diffuser 114 is disposed in the housing 102 at a first end toward the inlet 108. The diffuser 114 comprises a plurality of orifices 116 having beveled edges which may be sized according to end use. The diffuser is configured to break apart the water molecule clusters and provide nano-particles under pressure from a pump. The elongated tubes 118 extends longitudinally within the housing 102 in the nucleation zone. In some embodiments, the elongated tubes 118 could be held or retained by a series of baffles, disposed within the housing 102. In some embodiments, the elongated tubes are 118 are held or retained by a pair of baffles at the top portion and a pair of baffles at the bottom portion of the hollow interior 104.

The elongated tubes 118 may be formed of copper together with other metals, and are formed into a bundle of tubes having a copper cathodes (shown in FIG. 2) in the center of the bundle thereof. The copper has a pH balancing effect on the fluid while the other stronger metals it may be used with provides enhanced strength. The elongated tubes 118 are is configured to suspend the water molecules that have been fissured by the diffuser 114.

In one embodiment, the nozzle 120 is disposed proximate the outlet and comprises a predetermined amount of perforations 122. In one embodiment, the nozzle 120 is radially spaced from the elongated tubes 118 at or near the outlet 110

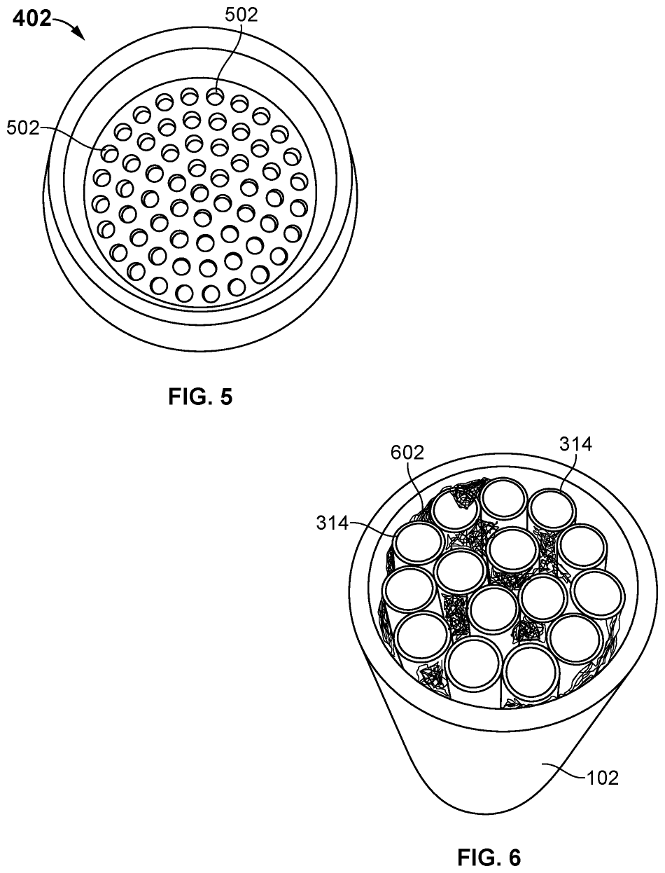

In another embodiment, the housing 112 further comprises a first connection member 130 at the inlet 108. In another embodiment, the first connection member 130 comprises a threaded tubular configured to connect to a fluid source. In yet another embodiment, the inner cylindrical housing 112 further comprises a second connection member 132 at the outlet 110. In one embodiment, the second connection member 132 comprises a threaded tubular, which is configured to connect to a snow gun 124 (shown in FIG. 5). In this way, the device is connectable to a pump at the inlet, and a retaining pond at the other. Or, in optional embodiments, it is connectable to a pump one end a feedback loop on the other to clean and pH balance water, such as swimming pool water.

Referring now to FIG. 2, in embodiments, the device 200 may be manufactured in different sizes having different dimensions depending upon the raw water to be cleaned or remediated. Further, the varying sizes may accommodate the various pipe dimensions in the various industries in which fluid or water remediation is needed. In this embodiment, the housing 102 is shown in a closed manner to contain the forces of cavitation in some embodiments in which scale is increased. In an exemplary embodiment, the device 200 has a diameter approximately five centimeters and greater. The inlet 106 comprises a first connection element 202 such as a threaded cap for connection to an existing system and a second connection element 206 for connection to an existing system. A nozzle (described in greater detail with FIG. 5.) is located near the outlet 104. While threaded connecting elements may be used, other forms of connection are contemplated such as frictions fits, soldering and the like.

Referring now to FIG. 3A exemplarily illustrates a side view of an orifice 116 of the diffuser 114 in an embodiment of the present invention. In one embodiment, the orifice 116 of the diffuser 114 is 1 inch in width, which is represented as “E”. the orifices are internally shaped to provide a venturi effect to thereby increase the hydrodynamic cavitation effect when the fluid is under pressure. In another embodiment, the orifices 116 are concentric opening having diameter of 0.1562 inches inch and a depth of 0.5 inches. In yet another embodiment, the orifice 116 of the diffuser 114 comprises an entry dimension of 5/32 inch (“F”) in diameter with an approximately 45-degree (“C”) chamfer and ½ inch in depth from the entry or input side of the orifices 116. Additionally, the orifice 116 of the diffuser 114 comprises an output dimension of 7/32 inch (“I”) in diameter and ½ inch (“D”) in depth from the exit or output side of the orifice 116. Referring to FIG. 3B, the output dimension of the orifices 116 of the diffuser 114 is illustrated.

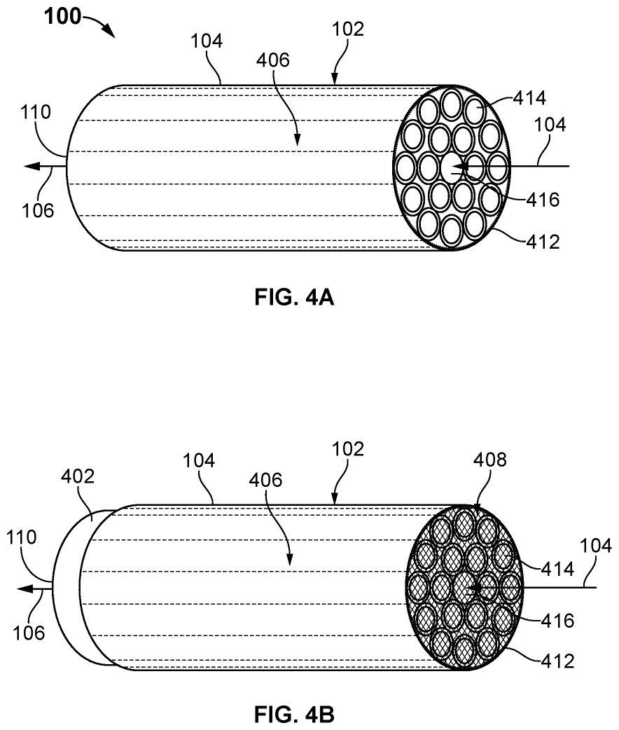

Referring now to FIG. 4a a perceptive view of the device 100 such that the interior of the housing back be partially seen. As shown, the hollow interior 104 of the housing 102 comprises a plurality of elongated cylindrical housings 118 each of which extend the length of the housing 102, and each of which will be described in greater detail with relation to FIGS. 4 and 5.

In one embodiment, the hollow interior 104 of the housing 102 defines at least a portion of the fluid nucleation zone therein. In one embodiment, the cylindrical housings 118 may be made of a metals, plastic, metal alloys, or ceramics. In an optional embodiment, any material with a hardness that will endure the effects of hydrodynamic cavitation may be used.

Referring now to FIG. 4b, as can be seen, the plurality of elongated tubes 118 are securely positioned within the housing 102 and configured to allow fluid via the inlet 104 of the device 100. In one embodiment, the plurality of elongated tubes 118 define the cavitation zone in the housing. The elongated tubes 118 may be retained by a series of baffles disposed between the one or more diffusers 120 and the nozzle 118 in the hollow interior 104 of the housing 102. In some embodiments, the elongated tubes 118 could be held or retained by, but not limited to, a pair of baffles at the top portion and a pair of baffles at the bottom portion of the hollow interior 106 of the cylindrical housing 102 therein. The elongated tubes 118 are configured to create a partial fusion process in which the fluid/water molecules come back together in close proximity but un-bonded and create a single molecule water particle, which instantly provides nano-clusters.

In one embodiment, the device 100 further comprises a mesh screen 412 located at the inlet and outlets, and a copper cathode 416 located in the interior 406 housing 102. In one embodiment, the mesh screen 412 is securely wrapped around the hollow interior of the housing 104 and extends longitudinally along the cylindrical housing 102 and is formed with a metal alloy mesh and holds the elements in place. The mesh may also act as an endcap.

Referring to FIG. 4b, a mesh cap 412 of the device 100 is shown at one end of the housing together with a nozzle 402 at another end. The mesh cap 412 is securely disposed at one end of the plurality of elongated tubes 118 within the cylindrical housing 102 of the device 100. The mesh cap 412 provide stability to the elements therein.

Referring to FIG. 5, the nozzle 402 of the device 100 is shown. The nozzle 402 comprises a plurality of holes 504 for fluid at the outlet. In one embodiment, the nozzle 402 is securely affixed to the outlet of the housing 102 using, but not limited to, fasteners or an adhesive means. The nozzle 402 is configured to control the flow of fluid. In one embodiment, the nozzle 402 comprises a predetermined amount of perforations 122. The nozzle 402 is configured to securely affixed to the outlet 110 of the cylindrical housing 102 for controlling the flow of the purified fluid. The diameter of the nozzle 402 could be varied based on the dimensions/sizes of the devices (100 and 200) (shown in FIGS. 1-2). In one embodiment, the nozzle 402 could be manufactured with a diameter of about, but not limited to, 2 inches. In another embodiment, the nozzle 402 could be manufactured with a diameter of about, but not limited to, 3 inches. In one embodiment, the diameter of the perforations 502 of the nozzle 402 could be varied according to the dimensions of the devices (100 and 200). In one embodiment, the plurality of holes or perforations 502 of the nozzle 402 is in a concentric opening configuration.

With reference now to FIG. 6, in an embodiment, the device 100 may be “stuffed” with steel wool or copper 602 that are relatively thin compared to the diameter of the housing. As such, the steel wool or copper is securely positioned between the elongated tubes 118 within the housing 102.

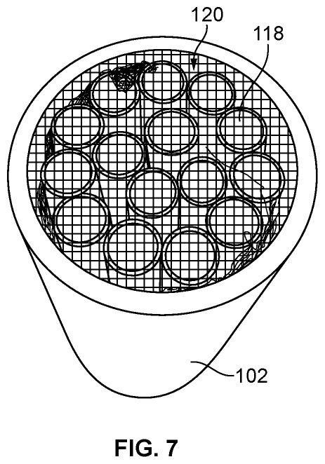

Referring now to FIG. 7, an end perspective view of the device 100 is shown. The housing 102 and elongated tubes 118 of the device 100 is shown, In one embodiment, the device 100 includes one or more tubes and a cathode. In an exemplary embodiment, at least fourteen tubes are securely positioned and after the fluid does The diffusers 120 are configured to break bonds between adjoining fluid molecules, thereby creating the fluid nucleation process within the cylindrical housing and cleaning the fluid. In one embodiment, the filter screen is shown. In one embodiment, the dimeter of each orifice 124 of the diffusers 120 has a width of about, but not limited to, 0.028 inches. In one embodiment, the diffusers 120 are made of copper. In one embodiment, the diffusers 120 comprise a plurality of orifices 116 in the concentric opening configuration. In some embodiments, the diffusers 120 are made of a material, but not limited to, steel, alloy, copper, and thereof.

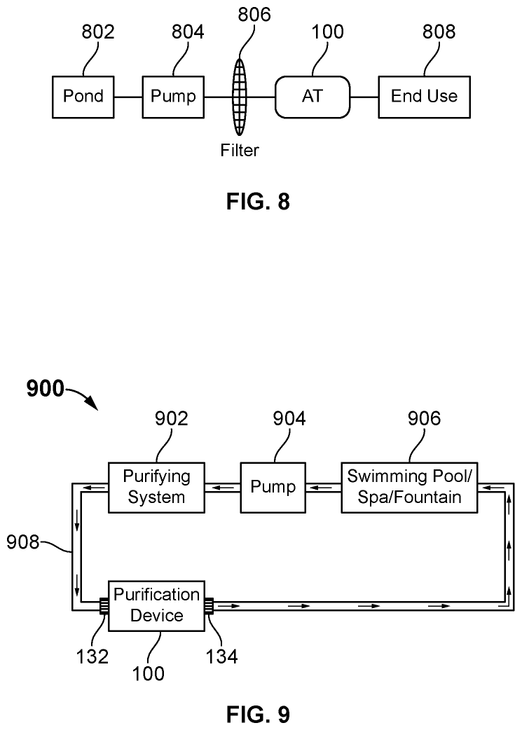

FIG. 8 is a flow-chart showing a use-case of the device at an agricultural pond in an exemplary embodiment of the present invention. The agriculture farm may be a livestock, chicken or pig farm, may be a vegetable farm, or hemp or cannabis farm, for example. As shown, pond 802 which requires treatment or disinfecting is shown. A pump 804 is provided in the flow line. The pump 804 takes water from the pond, and pressurizes the water based on the table 1 below. A filter 806 may be used to filter out debris over 30 um, for example. The filter may be employed before the pump as well. The device 100 is used to remediated or disinfect the water via hydrodynamic cavitation and then the water goes to an end use 808.

The pump 804 may be optimized to provide the pressure required for hydrodynamic cavitation as shown in Table 1 below:

TABLE 1

| | 111 | 222 | 344 | 360 | 480 |
|---|---|---|---|---|---|
| GPM | PSI | PSI | PSI | PSI | PSI |
| 5 | 40 | — | — | — | — |
| 10 | 18 | 40 | — | — | — |
| 20 | 7 | 22 | 40 | — | — |
| 30 | 5 | 15 | 21 | — | — |
| 35 | 5 | 14 | 18.5 | 40 | — |
| 40 | 0 | 13 | 17 | 28 | — |
| 50 | 0 | 12 | 16 | 23 | 40 |
| 60 | 0 | 11 | 15.5 | 21 | 31 |
| 70 | 0 | 10 | 14.7 | 19.3 | 27 |
| 80 | 0 | 0 | 14 | 18 | 25 |
| 90 | 0 | 0 | 13 | 17 | 23.5 |
| 100 | 0 | 0 | 12.5 | 16 | 23 |
| 110 | 0 | 0 | 12.3 | 15.5 | 22.5 |
| 120 | 0 | 0 | 0 | 15.25 | 22 |
| 130 | 0 | 0 | 0 | 15 | 21.7 |
| 140 | 0 | 0 | 0 | 14.5 | 21.4 |
| 150 | 0 | 0 | 0 | 14.3 | 21 |
| 160 | 0 | 0 | 0 | 0 | 21 |
| 170 | 0 | 0 | 0 | 0 | 21 |
| 180 | 0 | 0 | 0 | 0 | 21 |
| 190 | 0 | 0 | 0 | 0 | 21 |
| 200 | 0 | 0 | 0 | 0 | 21 |

In Table 1 above, 111, 222, 344, 360, and 480 represent the diameter if the nozzle and the number of orifices in the nozzle as follows:

111: 1 inch diameter and 11 orifices;

222: 2 inch diameter and 22 orifices;

344: 3 inch diameter and 44 orifices;

360: 3 inch diameter and 60 orifices;

480: 4 inch dimeter and 80 orifices.

Referring still to Table 1, the device may have various sizes based on the fluid to be treated and the use case. As an example, the device may be relatively smaller if a water in a spa is to be treated, whereas if a pond, lake or river is to be treated, the device, nozzle size, and number of orifices will increase. When the dimensions change, the PSI must be increased to produce the desired effect as shown in Table 1. The amount of water to be treated (gallons per minute or GPM) also changes with the diameter of the nozzle, and the housing generally influences. Table 1 shows the nozzle size and the required PSI (pound-force per square inch) to generate cavitation in the fluids.

Referring to FIG. 9, the device 100 is securely installed and fluidly connected to an outflow line or back-flow pipe 908 of a purifying system 902 is disclosed. In an exemplary embodiment, a pump 904 could be used to draw water from at least any one of, but not limited to, a swimming pool, spa, fountain, pond 906. In one embodiment, the device 100 is securely and removably affixed to the outflow line or back-flow pipe 908 of the purifying system 902 for at least any one of, but not limited to, the swimming pool/spa/fountain 906 using a first connection member 132 and a second connection member 134 for purifying and cleaning fluid without using chemicals. In one embodiment, the first connection member 132 at the inlet 108 of the device 100 is securely and threadedly connected to one end of the outflow line or back-flow pipe 908 and the second connection member 134 at the outlet 110 of the device 100 is securely and threadedly connected to a pipe, which is connected to an inlet of the at least any one of the swimming pool/spa/fountain 906. In one embodiment, the first connection member 132 comprises a threaded tubular, which is configured to connect to the one end of the outflow line or back-flow pipe 908. In one embodiment, the second connection member 134 comprises a threaded tubular, which is configured to connect to a pipe that is connected to an inlet of the at least any one of, but not limited to, the swimming pool, the spa, the pond, and the fountain. In some embodiments, the devices (100 and 200) are connected directly between an inlet and an outlet of at least any one of, but not limited to, a swimming pool, a pond, a spa, and a fountain for cleaning and maintaining the pH level of water via the pump 904 without using the purifying system 902.

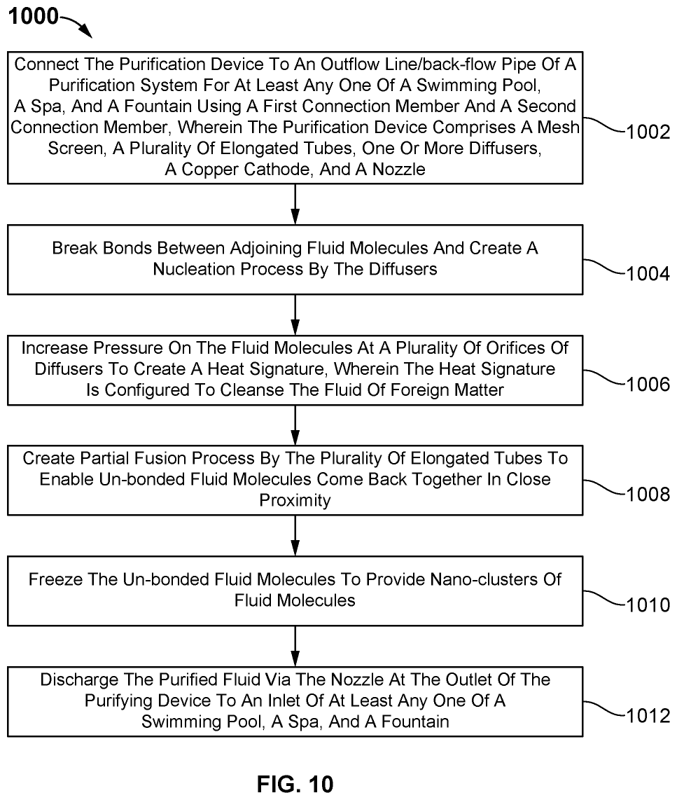

Referring to FIG. 10, a flowchart of a method 1000 for creating fluid nucleation in situ using the device 100 (shown in FIG. 1) in an embodiment of the present invention. At step 1002, the device 100 is removably and threadedly connected to the outflow line/back-flow pipe 130 of a purifying system 128 for at least any one of, but not limited to, a swimming pool, a spa, and a fountain using a first connection member 132 and a second connection member 134, wherein the device 100 comprises a cylindrical housing 102, a mesh screen 112, a plurality of elongated tubes 118, a copper cathode 116, and one or more diffusers 120. At step 1004, the diffusers 120 are configured to break bonds between adjoining fluid molecules and generate a fluid nucleation process within the cylindrical housing 102. At step 1006, the pressure on the fluid molecules is increased at the plurality of orifices 124 of diffuser 120 to create a heat signature, wherein the heat signature is configured to cleanse the fluid of foreign matter. At step 1008, the elongated tubes 118 are configured to create a partial fusion process to enable un-bonded fluid molecules to come back together in close proximity. At step 1010, the un-bonded fluid molecules are frozen to provide nano-clusters of fluid molecules. At step 1012, the purified fluid is discharged via the nozzle at the outlet 110 of the device 100 to an inlet of at least any one of, but not limited to, a swimming pool, a pond, a spa, and a fountain.

Advantageously, the present invention provides an intermediary device or nozzle 100 that is positioned within the flow of water and functions by the pressure created from a pump 126 or other devices to increase the pressure of water flow through a confined space such as a hose or pipe. The devices (100 and 200) further provide a fission process that breaks the surface tension and bond between adjoining fluid molecules. The present invention further creates a heat signature that forces the water molecules apart in a hydrophobic environment and burns off any foreign matter, thereby cleansing the fluid molecule. The present invention further provides a plurality of elongated tubes 118 that creates a partial fusion process in which the un-bonded fluid molecules come back together in close proximity. The devices (100 and 200) are provided with an ability to manipulate the bonding and un-bonding of water molecules within a pressurized environment.

Further, multiple results and outcomes could be achieved by varying the number of holes 124 or orifices 122 that enhance the ability to utilize a collective source of fluid or water molecules in a variety of applications. The devices (100 and 200) further provide water free of bacteria, algae, and other foreign matter and contaminants while maintaining a balanced pH level, for example, the devices (100 and 200) could be incorporated in a swimming pool. In another application, the devices (100 and 200) could provide a larger water crystal or snow particles when the individual water molecule is exposed to freezing temperatures.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

We claim:

1. A purification device for creating fluid nucleation in situ, the purification device comprising:
a cylindrical housing with a hollow interior, an inlet, and an outlet, wherein the hollow interior of the cylindrical housing defines a fluid nucleation zone;
a plurality of elongated tubes securely positioned within the housing, wherein the plurality of elongated tubes is configured to allow the fluid via the inlet;
one or more diffusers securely disposed at one end of the plurality of elongated tubes within the cylindrical housing, wherein the one or more diffusers are configured to break bonds between adjoining fluid molecules, thereby creating to fluid nucleation process within the fluid nucleation zone in cylindrical housing to clean the fluid;
a copper cathode disposed within the cylindrical housing, wherein the copper cathode is configured to balance the pH of the fluid, and
a nozzle having a predetermined amount of perforations therein, wherein the nozzle is configured to securely affixed to the outlet of the cylindrical housing for controlling a flow of the fluid.

2. The purification device of claim 1, wherein the device is securely and removably connectable an back-flow pipe of a purifying system for at least any one of a pond, swimming pool, a spa, or a fountain using a first connection member and a second connection member, wherein the device is used to purify and clean fluid using hydrodynamic cavitation.

3. The purification device of claim 2, wherein the first connection member at the inlet of the purification device is securely and threadedly connected to one end of the back-flow pipe and the second connection member at the outlet of the purification device is securely and threadedly connected to a pipe that is connected to an inlet of the at least any one of the pond swimming pool, spa, or the fountain.

4. The purification device of claim 1, wherein the one or more diffusers have orifices with beveled edges to create a venturi effect.

5. The purification device of claim 4, wherein the plurality of orifices is configured to increase pressure on the fluid to create a heat signature for cleaning the fluid of foreign matter, wherein each orifice of each diffuser has a width of about 0.028 inches.

6. The purification device of claim 1, wherein the one or more diffusers are made of a material or any combination of alloys.

7. The purification device of claim 1, wherein the plurality of elongated tubes are made of alloy, wherein each elongated tube has a diameter ranges from about 0.375 to 0.5 inches.

8. The purification device of claim 1, wherein the copper cathode has a diameter of about 0.5 inches.

9. The purification device of claim 1, further comprising a mesh screen endcap having a plurality of openings, wherein the plurality of openings has a width of about 0.028 inches.

10. The purification device of claim 1, further comprising steel wool stuffed in the cylindrical tubes surrounding the elongated tubes.

11. A method for creating fluid nucleation in situ using a purification device, comprising the steps of:
connecting the purification device to an back-flow pipe of a purifying system for a body of water using a first connection member and a second connection member, wherein the purification device comprises a plurality of elongated tubes, one or more diffusers, a copper cathode, and a nozzle;
breaking bonds between adjoining fluid molecules and creating a fluid nucleation process by the one or more diffuser;
increasing pressure on the fluid molecules at a plurality of orifices of the diffusers to create a heat signature, wherein the heat signature is configured to cleanse the fluid of foreign matter; and
creating a fusion process by the plurality of elongated tubes to enable un-bonded fluid molecules to come back together in close proximity for purifying and cleansing the fluid.

12. The method of claim 11 further comprising a step of, discharging the purified fluid via the nozzle at the outlet of the purification device to an inlet of at least any one of a pond, swimming pool, a spa, and a fountain.

13. The method of claim 11, wherein the purification device is securely and removably affixed to a back-flow pipe of a purifying system for at least any one of a swimming pool, a spa, and a fountain using a first connection member and a second connection member for purifying and cleaning the fluid without using chemicals.

14. The method of claim 13, wherein the first connection member at the inlet of the purification device is securely and threadedly connected to one end of the back-flow pipe and the second connection member at the outlet of the purification device is securely and threadedly connected to a pipe that is connected to an inlet of the at least any one of a swimming pool, a spa, and a fountain.

15. The method of claim 11, wherein the one or more diffusers have orifices with beveled edges to create a venturi effect.

16. The method of claim 15, wherein the one or more diffusers comprise a plurality of orifices thereon, wherein the orifices are configured to increase pressure on the fluid to create a heat signature to cleanse the fluid of foreign matter, wherein the plurality of orifices of each diffuser has a width of about 0.028 inches.

17. The method of claim 11, wherein the one or more diffusers are made of a material or any combination of alloys including steel and copper.

18. The method of claim 11, wherein the plurality of elongated tubes has a diameter ranges from 0.375 to 0.5 inches.

19. The method of claim 11, wherein the copper cathode has a diameter of about 0.5 inches.

20. The method of claim 11, wherein the mesh screen at the outlet and inlet extended has a plurality of openings, wherein the plurality of openings has a width of about 0.028 inches.
